(19) United States
(12) Patent Application Publication
(10) Pub. No.: US 2005/0107098 A1
(43) Pub. Date: May 19, 2005

(54) Method and system for enhance utilization of a cell phone

(76) Inventor: Oliver Wendel Gamble, New York, NY (US)

Correspondence Address: Oliver W. Gamble, 436 East 75 Street, New York, NY, 10021, US

(21) Appl. No.: 10/762,411

(22) Filed: Jan. 22, 2004

Related U.S. Application Data
(60) Provisional application No. 60/520,755, filed on Nov. 18, 2003.
(60) Provisional application No. 60/524,819, filed on Nov. 25, 2003.

(51) Int. Cl. H04Q 7/20

(52) U.S. Cl. 455/462

(57) ABSTRACT

This invention will provide a means by which an extension phone can be attached to a wireless telephonic device. The addition of an extension to a cell phone will enable it to provide increase access and functionality. The extension phone capability will allow for greater access to the cell phone, ability to add on additional electronic devices, ability to personalize the behavior of the extension phone to mimic that of the cell phone (ringing signal), and the ability to hold multi-person conversations.

### FIELD OF THE INVENTION

I claim the priority of provisional patent application 60/520,755 filed on Nov. 18, 2003, and. 60/524,819 filed on Nov. 25, 2003, these applications are incorporated by reference in their entirely.

The ever-increasing number of cell phone users will necessitate a means of connecting landline and a wireless communication system. This connection need not be merger of the two systems (wire and wireless), but rather a method of using a cell phone as both a mobile and stationary communication device. This invention will fulfill this need.

The present invention relates generally to a method and system for linking line phone extensions to a cellular phone. These extensions will be referred to as E-Phones and E2Phone. Typically a base unit of a wireless device is used for recharging the battery. The Base Unit used in a SkyRider has one or sockets that a line phones can be plugged into. An E-Phone is a phone that appears as regular line phone in and home or office setting, only it plugs into an enhanced Base Unit of a cell phone. The users of an E-Phone can conduct group conversations over a cell phone. An E2Phone is a phone with intercom and visual functionality. The users of an E2Phone can view images and conduct group conversations over a cell phone. The ability to link one or more E-Phone/E2Phone to a cell phone, making it possible for a single wireless device to provide service from several different locations.

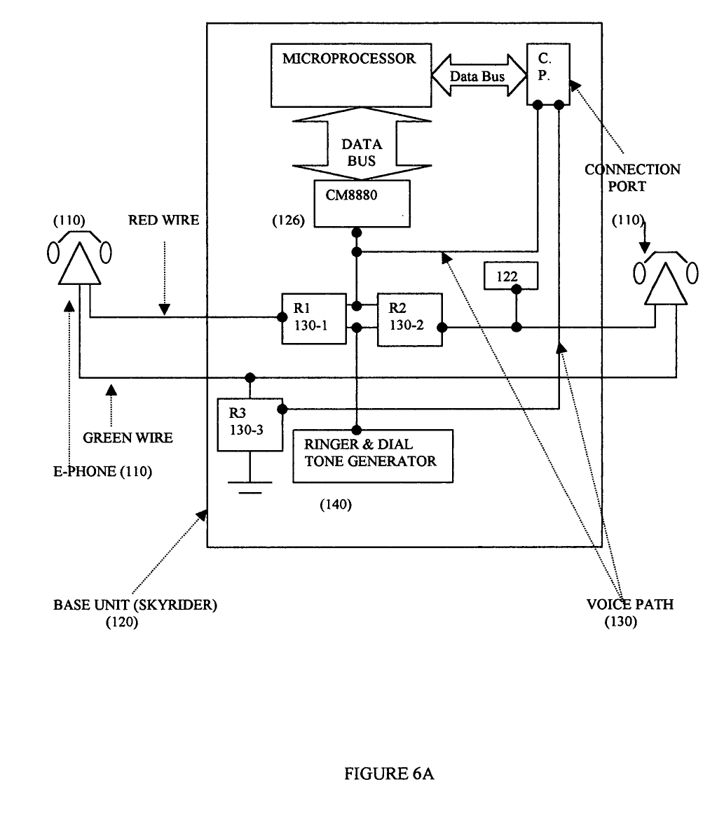

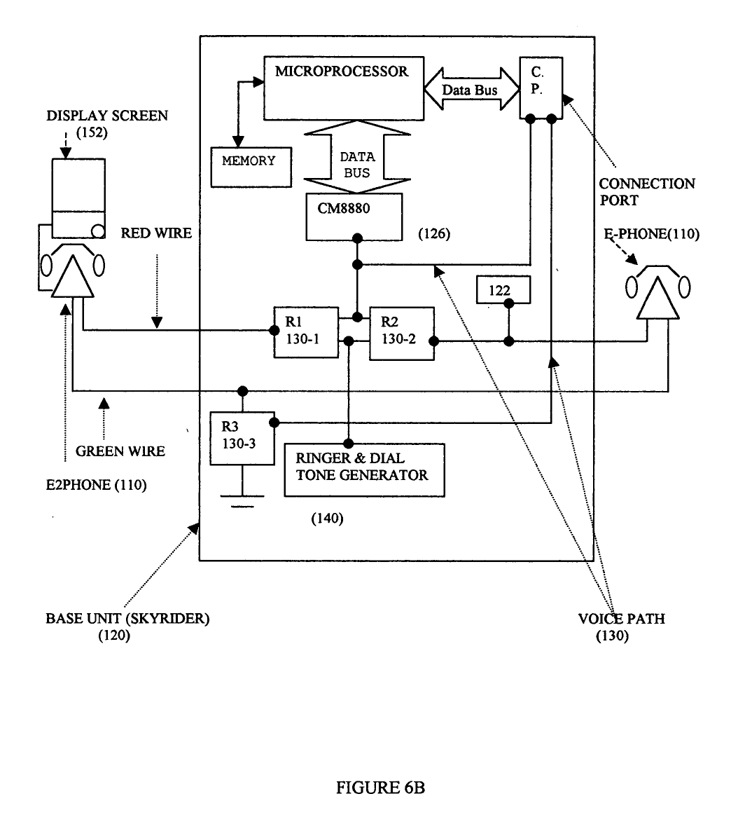

A SkyRider Base Unit will have telephone jacks, and the components need to for it to support the operation of E-Phone/E2Phone linked to it (FIG. 6), in addition to the components necessary for its normal recharging role. An E-Phone interfacing with a SkyRider will behave as if it were a regular lined phone (Wired), allowing the user to make incoming and outgoing calls. All calls and charges incurred from use of the E-Phone will be billed to the wireless cell phone account.

E-Phone user will benefit from the comfort and ease of being able to use their cell phone in any room in a house, not having to use a small fragile dialing device, always knowing where there cell phone is located, and all of the advanced features that are being added to cell phones. The multifunctional features of a cell phone can be distributed to the user house/office communication system. The ability to use the cell phone while it is charging. The SkyRider ability to mimic a regular line signaling will enable its user to attach regular line phone external devices to it (i.e. Fax machines, or digital cameras).

### DETAILS DESCRIPTION

Basic Of Wireless Telephones

A Cell phone requires three communication channels/frequencies to operate: one channel for incoming voice communication, one for outgoing voice communication, and one for control and regulations instruction for the cell phone. The separate channels for incoming and outgoing communication/conversation allows both the calling and answering parties to speak at the same time and be heard. This functionality is mimics that of a regular line phone.

There is a variety of chips in a cell phone, the major chip components are the analog-to-digital and digital-to-analog conversion (A-D & D-A) chip, digital signal processing chip (DSP), memory chip, and a the microprocessor chip. Each of these chips plays a significant role in the operation of a cell phone. Conversation/information is transmitted through the wireless communication network in a compress digitized format. The cell phone receives a compressed digitized package of information from a caller via the wireless network. The package contains both conversation and information about how to maintain the linkage with the caller. The information in the package was process (digitized and compressed) before it was transmitted to the receiving cell phone. The receiving cell phone will capture and de-process the transmitted package: decompress the digitized, and then convert the digital signal into an analog signal. The digital signal processing (DSP) chip, is a highly customized processor designed to perform signal-manipulation calculations at high speed. DSP are rated upward of 40 MIPS (Millions of Instructions per Second) and handles all of the signal compression and decompression within the wireless device. The incoming communication is translated from its digital format to analog by an audio chip that converts “Digital to Analog and Analog to Digital”. The outgoing conversation/communication is picked up by the microphone and converted into an analog signal, that is digitized and compressed before being transmitted by the wireless device (cell phone) back to the network.

The wireless device microprocessor handles all of the back-end operations of the cell phone: keyboard input and command request, display of information and pictures, commands and controls signaling (third channel) with the base station and everything else.

Memory in a cell phone comes in the form of ROM (Read Only Memory) and Flash memory chips. The wireless device memory is used for storage of the phone's operating system and customizable features: ringing, calendar, and directory.

The radio frequency (RF) and power section handle power management and recharging, and also deals with the hundreds of FM channels that are available to the phone for transmitting and receiving communication. Finally the RF amplifier handles signals traveling to and from the antenna.

The wireless device microprocessor handles all of the housekeeping chores for the keyboard, display panel, command and control signaling with the base station, and also coordinates the rest of the functions on the board. The ROM and Flash memory chips provide storage for the phone's operating system and customizable features, such as the phone directory. Lastly, the RF amplifiers handle signals traveling to and from the antenna.

The Digital Signal Processing chip (DSP) in a wireless device is highly flexible in its programmability: it can be program to perform a wide variety of tasks. This programmable high-speed microprocessor can be programmed to monitor the signaling between a Base Unit and a cell phone, enabling the Base Unit Microprocessor to introduce information and commands into the wireless device. These commands and instructions can convey the outgoing telephone numbers to the wireless device dialing buffer and effect their being dialed. The combination of memory, program coding, and a programmable microprocessor to run the coding can be used to create a virtual PBX. SkyRider working with the wireless device will function as a PBX for the E-Phones/E2Phone (Extension Phones), enabling them to send and receive calls like a regular line phone.

Basics Of Wired Telephones

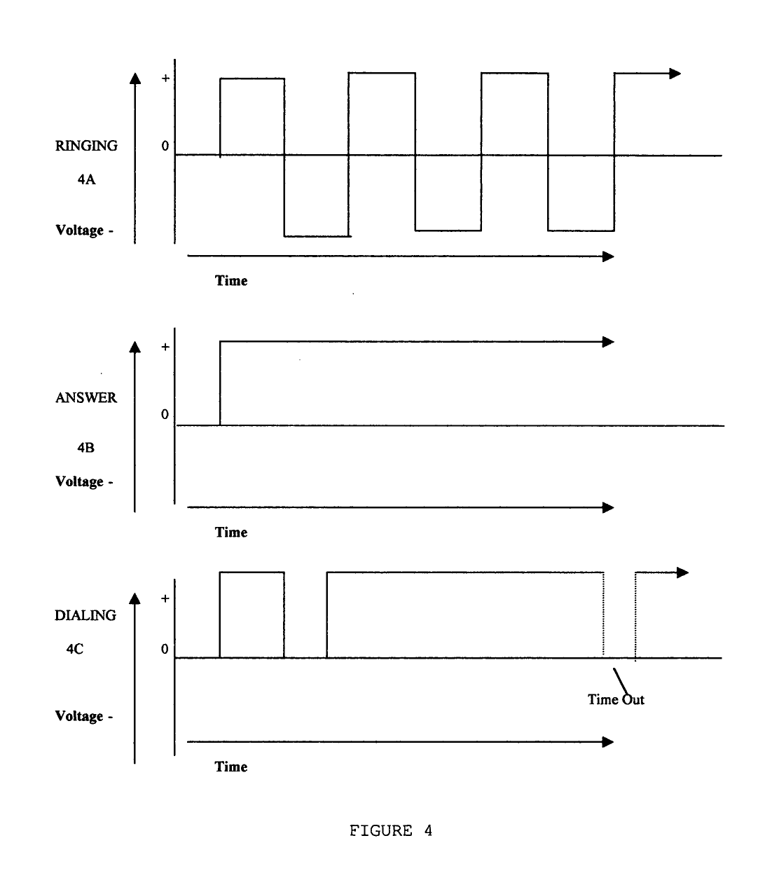

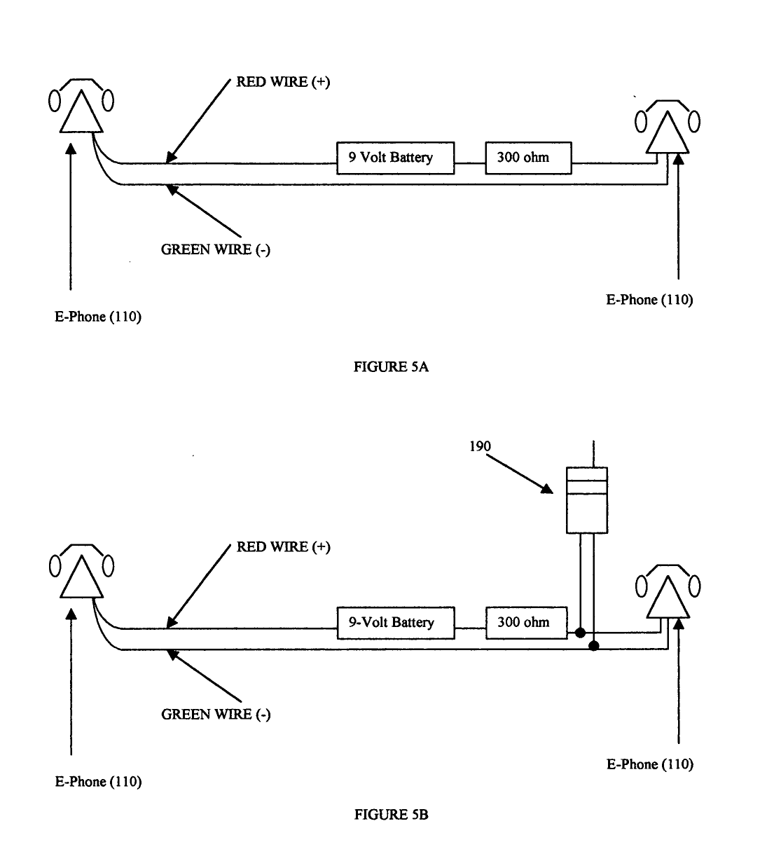

Each subscriber to a wired telephone is connected to a central office that contains switching equipment, signaling equipment, and batteries that supply direct current to operate the telephone. The telephone is connected to the central office by what is termed a local loop, a pair of wires. One wire is called the “Tip” and the other wire is called the “Ring”, or “T” and “R” respectively. A phone can be said to be in a neutral state when it is not in use, the handset is resting on the cradle (On Hook). When the handset is lifted from the cradle (Off Hook), a closed circuit is created between the central office is applying a small voltage to it over the line and the telephone. When a phone is on the hook (On Hook state), the central office will see it as an open circuit (incomplete local loop). The central office will monitor the state of the customer's line/local loop to detect Off Hook state (outgoing call). The local loop will appear as a completed local loop/closed circuit when the subscriber pick up the receiver (handset). The ringer, mean by which the subscriber is notify of an inbound call, is connected a crossed the wired pair in a manner that will allow the central office to sent a signal to the phone (ringing). The ringing signal sent from the central office consist of a 70 to 90 volt AC signal at 17 Hertz to 20 Hertz transmitted over a local loop (subscriber phone line) from the central office (FIG. 4A). Dial tone can vary from country to country, in America it is an unbroken distinct signal composed to two separate tones: 350 Hertz and 440 Hertz. Both the dial tone and the ringing signal are generated in the Central Office, not the telephone. The telephone has the ringer that response to the ringing signal sent from the Central Office. The ringer will ring when ever it encounters an incoming ringing signal, and will stop when the phone's handset is pick up (Off Hook). The Central Office generates a ringing signal whenever it has an inbound call for the subscriber. The subscriber will hear the ringing and know to pick up the phone to answer an incoming call.

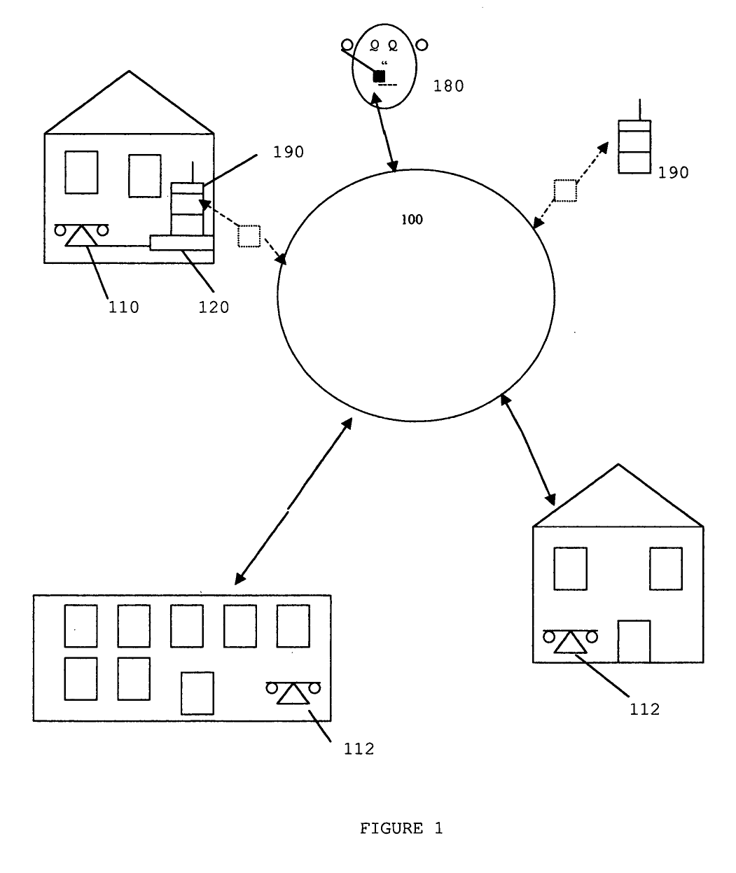

An incoming call is indicated by ringing signal on the recipient's phone send from the Central Office. The central office can detect the picking up of the recipient's phone's handset (Off Hook state), and will stop sending the ringing signal. The Central Office will then connect the incoming call to the recipient's local loop (FIG. 1 and FIG. 4B). When the call is completed and the recipient or caller hangs-up (On Hook state) is detected the phone goes back in to a neutral state.

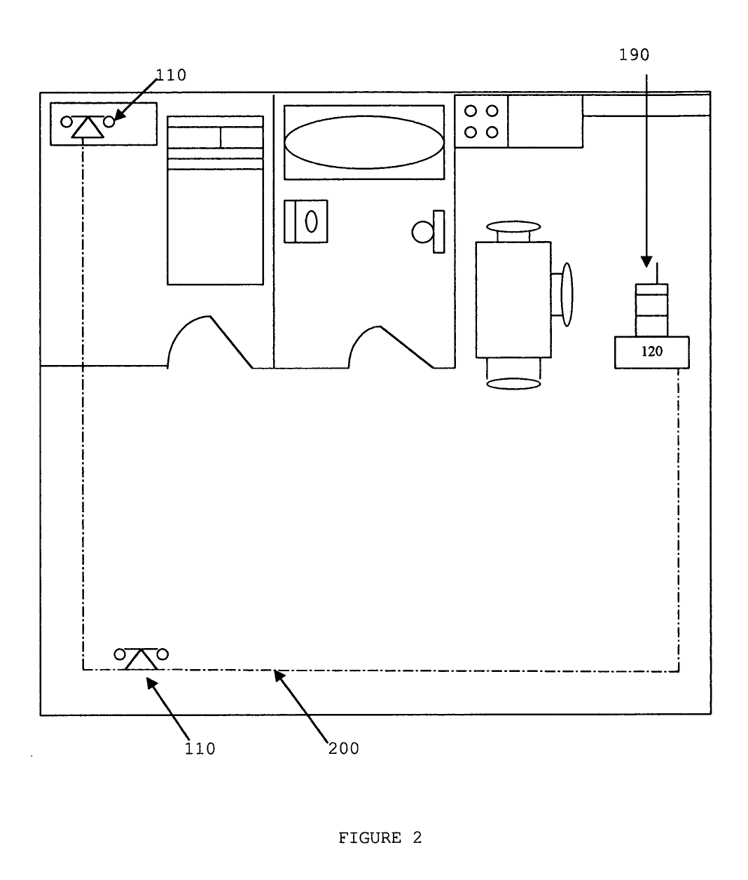

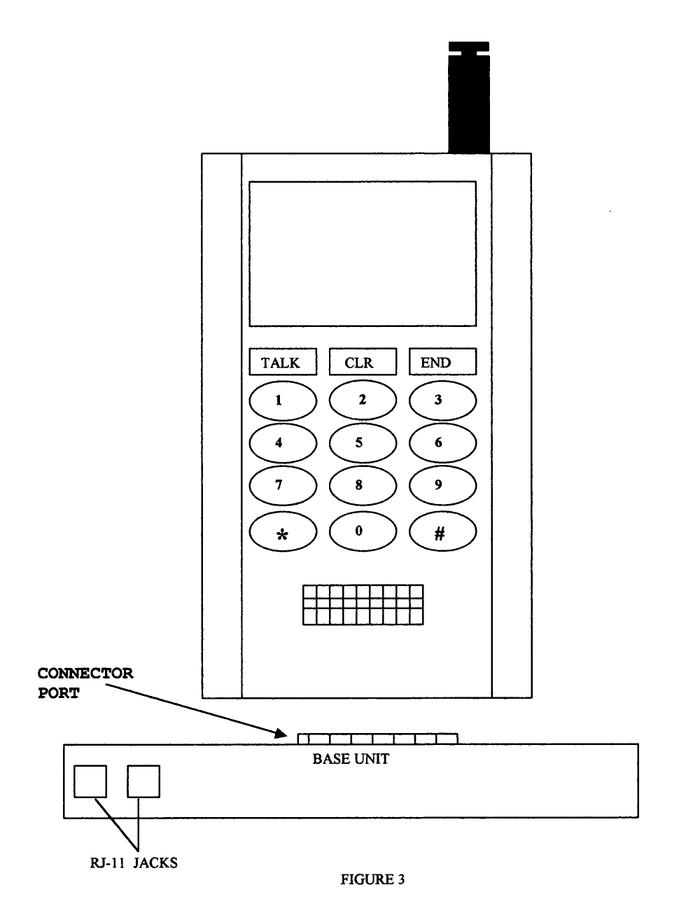

An outgoing call is detected by the Central Office when the subscriber picks up the handset creating an Off Hook state. When the subscriber picks up the handset, the open circuit connecting the Central Office to the phone is closed (local loop is completed), and current flow through it. The flowing current takes the form of a Dial tone, two monotones of 350 Hz and 440 Hz forming a distinct DTMF tone. The Dial tone lets the subscriber know that their phone is connected to the Central Office (FIG. 2C) and is ready to accept the phone number that they are about to dial. Once the user dials the first digit of the phone number the Central Office will stop the dial tone and connect the dialed phone number.

SkyRider

A SkyRider can be divided into three components, a wireless device (cell phone), a Base Unit, and one or more extension phones (E-Phones) linked to the Base Unit. Both the wireless device and the extension phone are plugged into the Base Unit. The wireless device is linked to the Base Unit by a Connection Port, located at the base of the wireless device. The extension line phone (E-Phone) plugs into the Base Unit at a normal telephone socket RJ-11). A normal telephone may serve as an E-Phone for a SkyRider, or a specially designed phone (E2Phone) may be employed as an extension for the cell phone in the SkyRider.

Two wired (line) phones can be used to form an intercom, all that is needed is a power source and a resistor. You can create an intercom out of two wired telephone by connecting the red wires to a 9-volt batter in series with a 300 ohm resistor, and the green wires to one another (FIG. 5). The resulting intercom system is the proto-type for an E-Phone(s). When this intercom system is linked to a Base Unit you get an E-Phone, an enhance intercom system (intercom system with the ability to generate DTMF-tones, redial, et cetera). This Intercom system will be able to generate/transmit DTMF-tone when key(s) on its keypad are pressed.

The Base unit of the SkyRider is composed of a Ring Generator, a microprocessor (Pic), DTMF-tone detector, a Dial-tone generator, optional display panel (Liquid Crystal Display), and an Off Hook state sensor.

FIGS. 6A & 6B illustrates one embodiment of the SkyRider (120) used in the system. The main components of the SkyRider (120) is a sensory array 122 (S1 and S2), relays 130 (R1, R2, & R3), stamp 124 (containing a micro-processing unit, EEPROM, clock and RAM memory), DTMF (Dual Tone Multi-Frequency) decoder and encoder chip 126, voltage regulator and a power supply. The SkyRider (120) will be interposed between and in E-Phones and the Cellular Phone as shown in FIG. 2 and FIG. 3A.

The sensor array (FIG. 6) 122 may consist of the following two sensors: ring sensor 122-1, and an answer/off hook sensor 122-2. The off hook/answering sensor 122-2, in one embodiment, comprises an alternating current optoisolator coupler. The coupler is attached to the phone line by a forward facing diode, allowing only positive current to flow through the diode and trigger the coupler. When the E-Phone 110 is off the hook, current flows through the phone line to the coupler. The light emitting diode inside the coupler activates a photo-transistor. The photo-transistor allows current to flow through it to a pin on the microprocessor. The microprocessor detects the current as a high signal, indicating the Off Hook status of the E-Phone. The ringing sensor 122-1 comprises an alternating current optoisolator coupler. The coupler may be attached to the phone line by a reverse facing diode, allowing only negative current to flow through the diode and the trigger of the coupler. Ringing is a process that employs both positive and negative moving current. The reverse facing diode allows only the negative current to reach the coupler. The light emitting diode inside the coupler, in one embodiment, activates a photo-transistor. The photo-transistor allows current to flow through it to a pin on the microprocessor. The microprocessor detects the current as a high signal, indicating ringing of the phone.

The optoisolator couplers employed, in one embodiment, is part number H11AA814AQT-ND or H11AA814QT-ND manufactured by Optoelectronics. The optoisolator triac may be part number MOC3010QT-ND also manufactured by Optoelectronics. Of course, other components and/or configurations may be used for accomplishing such monitoring.

The relays 130 used in one embodiment of the Skyrider (120) have both a normal close circuit and a normal open circuit. The application of a current to the coil will cause the normally open circuit to close, and the normally closed circuit to open. The default state (no power applied to the coil) allows a telephone call to pass through the SkyRider (120). In the default state the E-Phone lines are connected to the Ring and Dial tone generator. Allow the microprocessor to introduce either a Dial tone or a Ringing signal into the E-Phone(s), enabling the SkyRider to emulate a Central Office. When a current is applied to the coils of relay 1 (R1) 130-1 and relay 2 (R2) 130-2, an alternate path is opened, one that routes the connecting E-Phone line to the DTMF encoder/decoder 126 and voice line. This re-routing of the E-Phone line allows the DTMF Transceiver (CM8880) to monitor/read DTMF tones originating from the E-Phone 110. The transceiver converts the dialed phone number from encoded as DTMF tones into binary code. The binary code is passed to the microprocessor via a data bus.

In one embodiment, the relays 130 used are part # G6E-134P-ST-US-DC5 made by Omron. Of course, other components and/or configurations may be used for accomplishing such control over the telephone line wiring.

A stamp (124) is employed by SKYRIDER (120) and comprises a PIC-micro-controller chip (microprocessor), PBasic interpreter chip (software language use to program the micro-controller), EEPROM (electrically erasable programmable read only memory), RAM (Random Access Memory), clock and ports through which information and instructions can be passed. In this embodiment these ports are called pins, and each pin may be in either a high or low state. The micro-controller uses the state of the sensor pins to monitor the phone line for activity. The sensors 122 are attached to specific pins on the micro-controller, and when these pins go high or low, the micro-controller via the program store in its memory, can determine what is happening. The micro-controller is able to detect an active phone state by monitoring the pin connected to the “S1” (off hook sensor). The relays 130-1 and 130-2 are used in the SkyRider (120) are attached to specific pins of the micro-controller. The micro-controller recognizes which pin is attached to which relay 130, and the program tells the micro-controller when each relay should be employed. The micro-controller can activate a specific relay by outputting a small voltage to the pin attached to that relay coil. When the pin goes high the relay 130 is activated, and when the pin goes low the relay 130 is de-activated. In one embodiment a stamp II (124) manufactured by Parallax Inc./Microchip Technology (part # PIC 16C57) is used. Of course, other components and/or configurations may be used for accomplishing such control and monitoring of SkyRider activity.

The CM8880 126 is a fully integrated DTMF transceiver. This transceiver 126 may be interfaced with a computer/microprocessor to detect and interpret DTMF signals. The transceiver 126 is attached to the E-Phone 110 via the alternate path created when the relay 1 (130-1) and relay 2 (130-2) are activated. By placing the transceiver (FIG. 6-126) connection on the alternate path of the phone line, it is protected from the high voltage of an E-Phone ringing. The phone ring consists of both forward and backward flowing (AC) current at a voltage level that could otherwise damage the transceiver 126.

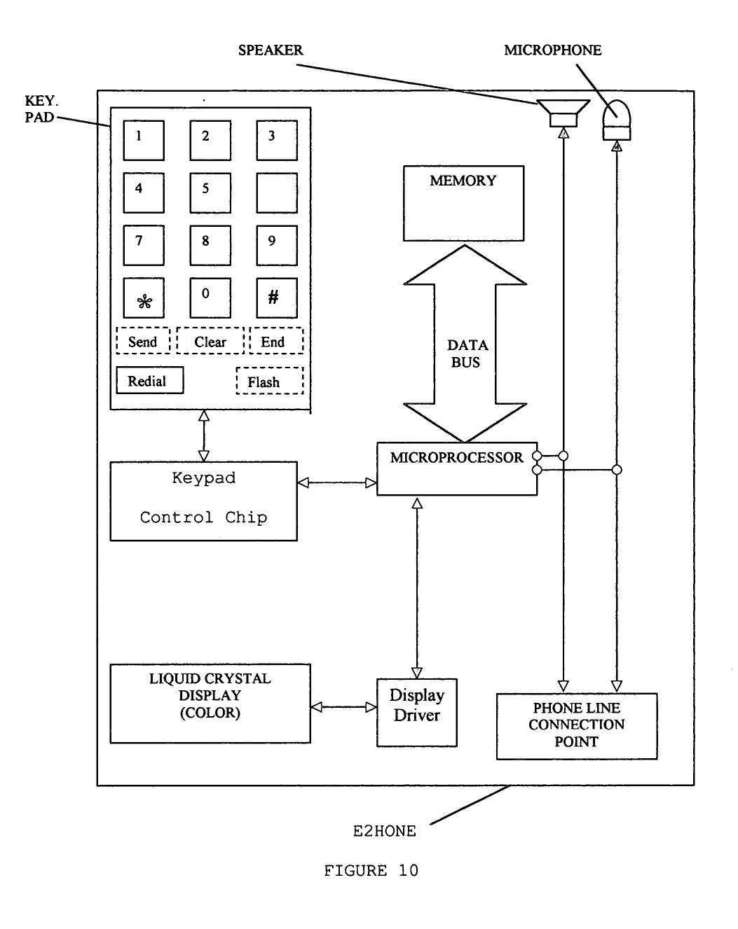

In an alternate embodiment the E-Phone can be all digital, and not require a high alternating voltage signal to make a ringing signal for the phone user. This embodiment would enable the E-Phone to take advantage of the cellular phone customize the ringing signal capability. This version of the E-Phone will be referred to as an E2-Phone (FIGS. 10 & 11). The E2-Phone will also have a display panel similar to that of a cell phone, allowing the user to view text messages and picture sent to them by other cell phones.

Once the microprocessor detects an outgoing call state, it triggers the relays 130 that bring the transceiver (FIG. 6-126) in contact with the phone line. This will enable the transceiver 126 to interpret the DTMF tones on the phone line, and pass it to the microprocessor. Although the current embodiment employs a CM8880 DTMF transceiver made by California Micro Devices (part # CM8880PI), other components and/or configurations may be used for accomplishing such decoding and encoding of DTMF.

A standard 9-volt and a standard 5-volt regulator may be employed as a power source for the SKYRIDER (120). The 5-volt supply may be used to power the DTMF transceiver 126, the relays 130, the sensors 122 to signal the microprocessor and the stamp (124). The 9-volt source powers the isolated telephone 110. The 5 volt and 9 volt regulators used by the SKYRIDER 126 may be, in one embodiment, Japan Radio Company part # NJM7809-FA and NJM7805-FA, respectively. Of course, other components may be used for accomplishing such regulation of voltage.

Connection Port

The Connection Port (FIGS. 6A & 6B CP) is a group of pins generally located at the bottom of the cell phone (wireless device). This port consists of a number of pins that are used to communication information and/or instructions between an external device and the cell phone. The external device also has a connection port compose of complementary fitting. The Connection Port can be used to link a wireless device to Personal Data Assistant (PDA), laptop computer, or hands free units that provide external microphones and headset. The SkyRider will use the Connection Port to link its microprocessor data bus with that of the Wireless device. This Data Bus will convey conversation, telephone numbers in the form of electrical signals (DTMF tone in one embodiment), and command instructions between the wireless device and the E-Phone (E2Phone). Many of the wireless phones already have the ability to convey conversation via the Connection Port to hand-free headsets that contain a microphone and a small speaker. The ability to accept dialing instruction and phone number via the Connection Port may or may not be already programmed into the wireless device. However this capability can be readily programmed into the cell phone by anyone skilled in programming the cell phone. Employing existing capabilities with the cell phone, or newly added described capability it is possible to make a SkyRider. The other Pins of the SkyRider will be used to detect and monitor the status of the cellular phone: know when it is ringing, or not in use.

In another embodiment the Pins in the Connection Port may be configured to activate key on the keypad of the cell phone, allowing the Base Unit to transmit instructions/information between the two devices: SkyRider and Cell Phone. The information will take the form of instruction to the cell phone to mimic the pressing certain command keys, or numeric key on the keypad. The SkyRider will be able to transmit commands and a specific Phone Numbers my manipulating the state of various pins/combination of pins composing the Connection Port of the wireless device. The cell phone will be able to communicate back to the Base Unit by manipulating it pins. Since each cell phone company/manufacture may have it own set of proprietary codes for handling input into and out of the cell phone via the connection port, each SkyRider will have to be designed and manufacture for a specific cell phone. However, if at some future date, this is standardized it will be possible for a SkyRider to work with any cell phone (wireless telephony device). Any engineer skilled in the art with access to the proper codes will be able to program the SkyRider to work with a cell phone.

Incoming Call

When the Cell Phone is ringing the appropriate pin of the cellular phone's Connection Port will signal this event. The Cell Phone Connection Port is interfaced with the SkyRider's Connection Port in a male to female configuration. The data bus linking the Connection Port to the SkyRider's Microprocessor (FIG. 6) will detect the state of the cell phone and trigger relays R1, R2, and R3 to a ringing position. The Ringing Position of the SkyRider Relays routes the red wire to the Ringer & Dial Tone Generator away from the CM8880 (FIG. 6-140). Relay R3 will be configured to provide a ground for the ringing signal, and protect the voice path from the high voltage of the ringing signal. The Microprocessor will signal the Ringer to generate a ringing signal on the E-Phone line. The E-Phone will start ringing when it experiences the alternation current signal. When subscriber lifts the handset (off hook state) the circuitry in the phone that response to the ringing will disengage and a close loop will exit. This closed loop will cause the off hoop sensory to go positive and the ringing sensor to go negative, creating a distinct sequence of events that the microprocessor will interpret as answering a phone call.

When the subscriber lifts the handset from it cradle an off hook state is created. The microprocessor monitoring the sensors will detect the off hook state, will respond by stopping the Ringing, re-route the red wire to the DTMF tone detector, establishing a close circuit for the voice path (FIG. 6).

The SkyRider will enter a neutral state once it has detected the lifting of the handset to accept the incoming call and it opens the voice path to the E-Phone. In the neutral state the SkyRider will become inactive until the call has ended. After the incoming call has ended the SkyRider will return to it wait state, looking for new outgoing calls or an incoming call. The voice path to the E-Phone is the same path that a hand-free set would use. Almost all cell phones are designed to accept a hand-free setup involving a speaker and microphone attachment.

Outgoing Calls

An outgoing call is detected when the subscriber/user lifts the handset out of the cradle and there is no incoming call. The SkyRider, monitoring the Sensory for the E-Phone will detect this as an outgoing call state, and will immediate check with the cell phone status to ensure that service is available. The SkyRider will then send signal to the Ringer & Dial Tone Generator instructing it to produce a Dial Tone. The duration of the dial tone can vary, from three seconds at the lifting of the receiver, to until the user enters the first digit.

In an alternate embodiment, the SkyRider can accept the user entered phone number even if there is no service at that exact moment (Cell Phone is unable to immediately establish connection with the wireless communication network). The SkyRider call pause briefly once it has the phone number while service is being established (access to the wireless communication network).

The SkyRider will signal to the Cell Phone via the Connection Port to prepare for an outgoing call. This will involve the Cell Phone microprocessor clearing the dial buffer/Check to make sure service is available to the cell phone. The SkyRider will also check to ensure that the Relays are properly set for the outgoing calls. All three relays are involved in the re-routing red for making an outgoing call. The Relays will establish the CM8880 detector/voice path to monitor the red wire for the DTMF-tones of the phone number being dialed by the subscriber. The DTMF-Tones are captured by the CM8880 and converted into binary and passed to the SkyRider's microprocessor via the connecting data bus. The SkyRider will interact with the cell phone microprocessor, setting it up to accept the dialed phone number. The SkyRider's microprocessor will communicate the captured phone number to the cell phone via the Connection Port. The transmitted phone number will properly format by the SkyRider before it is passed through the connection port to the cell phone. The Passed phone number will appear as either a phone number entered from the cell phone's memory, or a phone number entered via the cell phone's keypad.

The Microprocessor will continue to monitor the E-Phone line (red wire) for the “#” (number symbol) that will trigger the dialing of the transmitted phone number. Cell phones require the user to press a specific button to initiate the dialing process. In another embodiment any designated Key/combination of keys on the keypad will trigger the dialing process.

In an alternate embodiment the SkyRider could trigger the dialing process whenever it captures twelve (12) digits, or when it captures twelve (12) digits plus a leading one (1). This embodiment would also have to make allowance for special phone numbers such as “911”, “0”, “411”, et cetera. That certain predetermine digits will trigger the dialing process when a specific number of digits are collected within a set time period. This will allow the E-Phone to deal with for international calls that begin with as “0” (i.e. 011-XYZ).

The SkyRider will enter a neutral state once it has dialed the capture phone number, it will only check to see if the call has ended. The SkyRider will stay in an inactive state until the call has ended, then it will return to it wait state, looking for new outgoing calls or an incoming call.

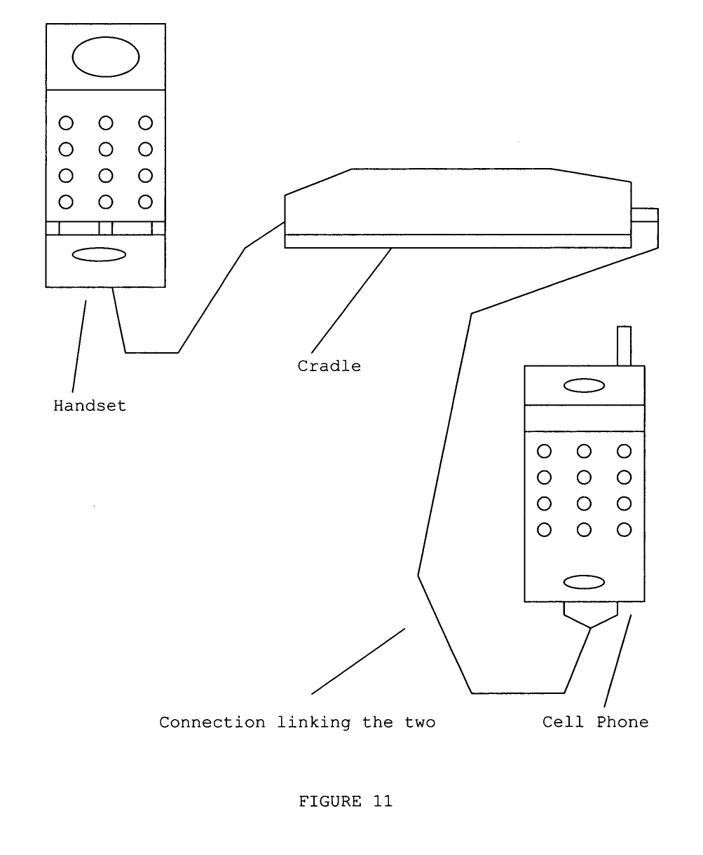

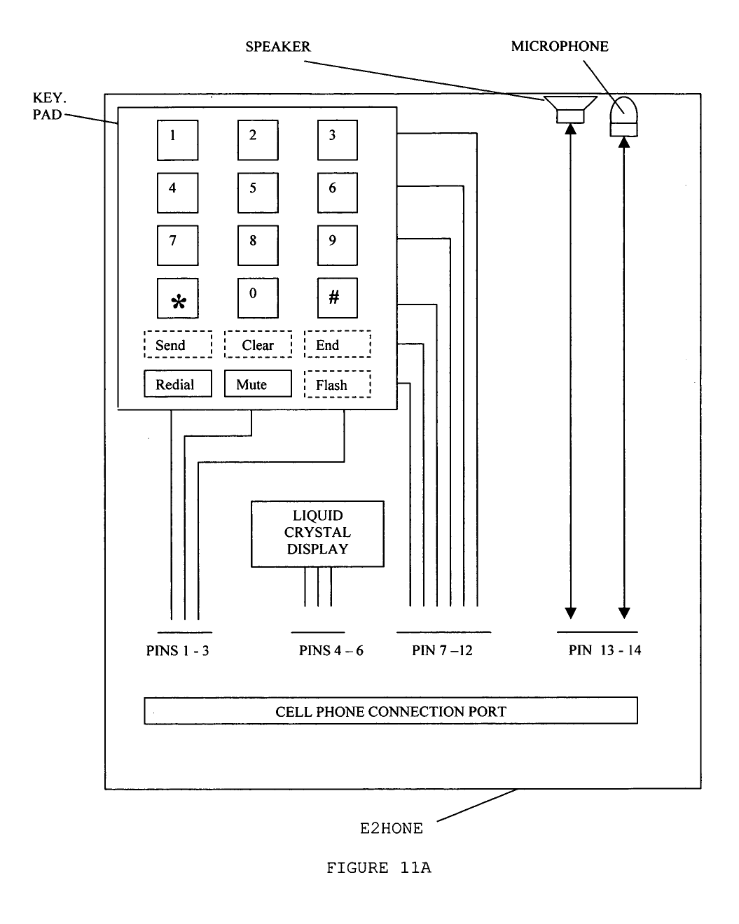

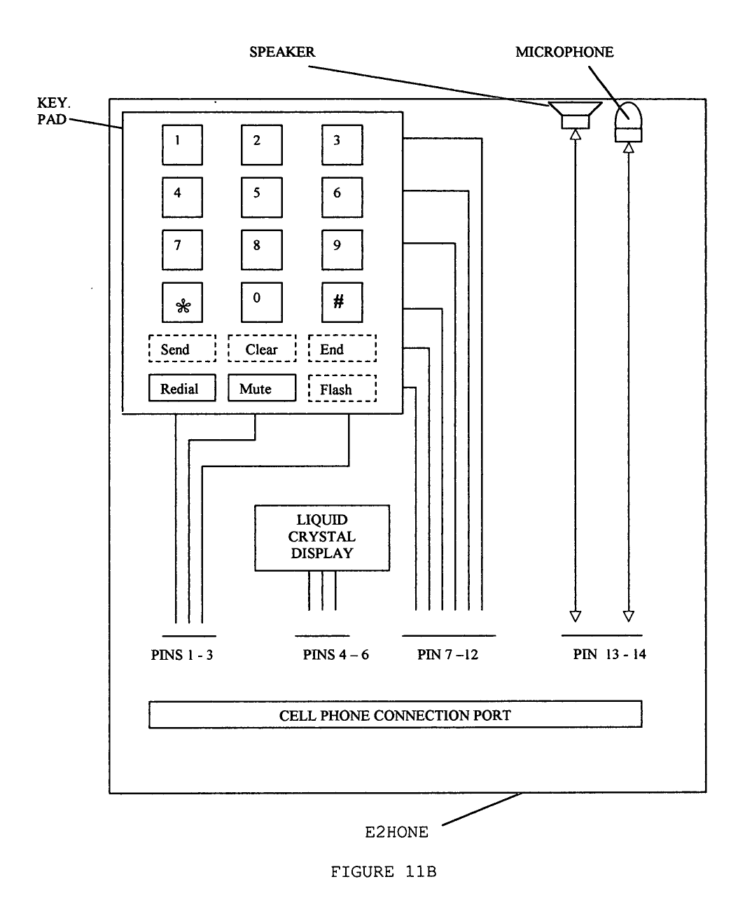

In alternate embodiment, components normally contained with a cell phone can be used to create a SkyRider. Cell phone have all of the components needed to create a SkyRider already inside of them. All that is needed is external access to these components. By adding an external keypad to the hand-free a speaker and microphone, you will create a SkyRider. FIG. 11 illustrates one embodiment of this approach to creating a SkyRider. The external Keypad and the hands-free headset (microphone and speaker) are linked to the cell phone (wireless device) via the cell phone Connection Port's pins. The Connection Port pins will link external keypad to the same circuits that normally monitor input from the cell phone's normal keypad. When input from either of the two keypads is indistinguishable from one another, and an external speaker and microphone is employed, you will have a SkyRider. Hands-free headsets are already readily to cell phone users, all that is needed is an external keypad and programming of the connection port to accept input from an external source as input from the keypad.

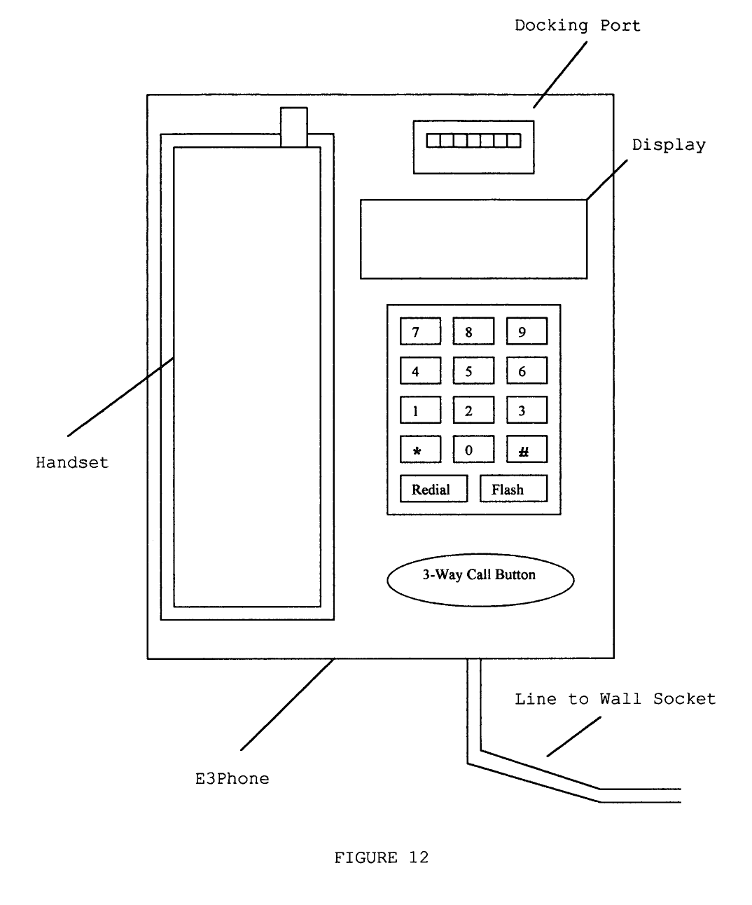

In another alternate embodiment it is possible to incorporate a SkyRider Base Unit into a regular line telephone (FIG. 12). This enhance telephone would be enable the user to handle both line calls and cell phone calls from the same telephone. This would be advantageous to workers that work inside and out of the office. The SkyRider telephone will allow the user to place either a line phone caller, or the cell phone caller on hold, by pressing a button. This will allow the user to effective use only one phone to handle all incoming calls.

FIG. 1 illustrates one embodiment of the SkyRider invention, in which a cellular phone and line phone (wire and wireless telephonic devices) are linked to a communication network (100). The communication network provides service to both wired telephones denoted as 112, and the wireless phone denoted as 190. The Base Unit of the SkyRider is denoted as 120, an operator is denoted as 180, and the E-Phone/E2Phone are denoted as 110.

FIG. 2 illustrates one embodiment of the SkyRider invention employed in a house/apartment. In this illustration, the skyRider has two E-Phones linked to it via common telephone line wire (two or four leads in the line). The wireless phone is plugged into base unit and the E-Phones are located about the house/apartment. This will allow the user of the SkyRider to access incoming call and make outgoing calls from any location within the house/apartment the say way they would with a regular line phone extension (only they are using a cell phone and accessing with E-Phone/E2Phone (extensions).

FIG. 3, illustrates one embodiment of the SkyRider's invention, showing a wireless device that used links it to a communication network and a Base Unit that is used to connect the E-Phone (E2Phone). The Base Unit has two RJ11 sockets for linking to the E-Phone. However, in another embodiment other types of sockets may be employed to connect to the E-Phone/E2Phone. The Base Unit may employ USB Ports and cable, Fiber Optics ports and cables, Coaxial ports Cable to connect to E-Phone(s)/E2Phone(s). The Connection Port on the Base Unit is male and will interface with a female counter part on the wireless device. This arrangement can be reversed, the wireless device can be male and the Base Unit can be female.

FIG. 4, illustrate the type of signal that a line phone (wired phone) normally encounters in the performance of its daily operations: signaling an incoming call, signaling the answering of an incoming call, and signaling to indicate and outing call is being made. When one telephone user calls another telephone user, the communication network signals the receiving party (user that is getting the call) to pick up their telephone handset to accept an incoming call. The common practice is for the central office to send an alternating current signal on the local loop attached to the receiving telephone. FIG. 4A is one embodiment of such a signal send to the receiving phone; the electrical signal will call ringing to occur. When the ringing telephone is handset is picked-up (answering the call), a switch at the central office is closed. The closing of the switch at the central office terminate the ringing signal, and connects the incoming call to the receiving telephone. FIG. 4B, illustrates one embodiment of the signal that is generated when a ringing telephone is answered by the receiving telephone user. FIG. 4C, illustrate one embodiment of what happens when a telephone user picks up a handset to make an outgoing call. It is important for the SkyRider to mimic these signals, they will allow for the user to be able to attached other device to it and have them function properly. One such attachment may be a fax machine. Such an attachment will expect to encounter signaling common to a normal phone line. The employment of regular telephones as E-Phone may also necessitate the need for the above described signaling for proper function.

FIG. 5A & FIG. 5B, illustrate the basic concept of an E-Phone evolving from a regular phone. A basic line phone can be converted into an intercom, by the simple addition of a 9-volt battery and a 300-ohm resistor. The telephone will provide the electronics needed to speak and be heard over the intercom system. By linking a cell phone to the intercom via a hand-free speaker and microphone connection (socket), it is possible to conduct a conversation via the intercom with a cell phone caller. FIG. 5B, illustrates one embodiment of line telephones forming an intercom system linked to a cell phone.

FIG. 6, illustrate one embodiment of a Base Unit linked to two E-Phones. In this embodiment, the two E-Phones are linked to the Base Unit by RJ11 sockets. Telephones line running from the E-Phones to the Base Unit plug into RJ11 sockets. The Cell Phone plugs into the Base Unit at the Connection Port (C.P.). The microprocessor is the heart of the Base Unit, it monitors and controls all of activity of the SkyRider. The microprocessor monitor and control the CM8880 (DTMF transceiver) to detected E-Phone dialed telephone numbers encode in DTMF-tones. The CM8880 can also introduce DTMF-tones into the E-Phone. The microprocessor controls an arrangement of relays to route signals and conversation within the Base Unit. The microprocessor configures the relays to route ringing signals to the E-Phone when the cell phone detects an incoming call. The ringing signal (FIG. 4A) is generated by a ring signal generator when the Base Unit microprocessor detect and incoming call. The microprocessor call detected incoming call by monitoring the activity status of the cell phone via the Connection Port. The sensor array (122) is used by the microprocessor to determine the status of the E-Phone. The microprocessor will only signal an incoming call when the E-Phone is on the hook (ring the phone). The microprocessor will also use the sensor array to determine the E-Phone is being used to make an outgoing call: when the handset is picked while no income call is occurring (FIG. 4C). The microprocessor working with memory and program coding will choreograph the various components of the Base Unit to allow incoming and outgoing call to occur over the E-Phones. A dialed E-Phone (E2Phone) number will be communicated to the Cell phone via a common data bus linking the microprocessor to the cell phone attached at the Connection Port.

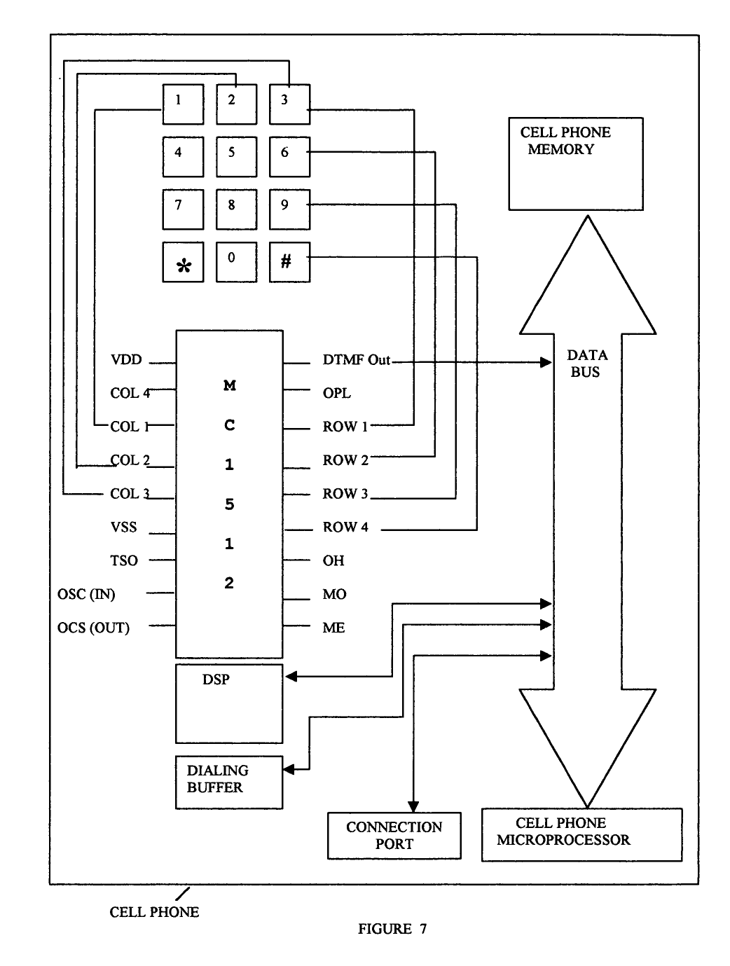

FIG. 7, illustrates one embodiment of how a cell phone might interact with the Base Unit via the Connection Port. The Connection Port is point at which the data bus of the Base Unit and The Cell Phone connect, and exchange information. An incoming call from the communication network will trigger pre-programmed events within the cell phone, decoding the incoming information packets that contain the set-up information for the call (telephone number of caller, what tower the call is coming from, what frequency it is being transmitted on, et cetera). As this information is being process with in the cell phone, program coding that instructs the cell phone to start ringing will be recognized by the microprocessor in the Base Unit. The Base Unit's microprocessor is able to detect the cell phone ring signal, because both the cell phone and the Base Unit share a common data bus (Connection Port). The Base Unit will activate the Ringer & Dial-tone Generator, causing the E-Phone (E2Phone) to ring. When the Base Unit microprocessor detects someone picking up the E-Phone handset, it will stop the ringing and signal the cell phone. The signal to the cell phone will be the same as when the user normally answers an incoming call, causing the voice communication to be established between the caller and the cell phone. The voice communication is routed to the E-Phone the same way that a hand-free headset would route to the speaker and microphone. When the user places the handset back into the cradle (terminating the call), the Base unit will present a signal to the cell phone microprocessor that is the same as a normal end call signal. An outgoing call from the cell phone could be performed for the following process, in one embodiment. When the cell phone user presses a key on the cell phone keypad a chip (MC14512) translates pressed keys into electrical signals (DTMF-tones) that are conveyed to the microprocessor. In an alternate embodiment, making this chip accessible to an external keypad can be used to create a SkyRider when employed with the hand-free headset circuit (FIG. 11, 11A). The cell phone's microprocessor will load the phone number into both the Dialing Buffer and Display Panel. The loaded telephone number is process by the DPS chip: digitizes and compressed the phone number, and other information into a packet(s). When the cell phone user pressed the dial/send key (the button that transmits that initiates the calling process), the data packet is transmitted over the communication network via the nearest cell phone tower. When an E-Phone user makes an outgoing call the phone number entered on it keypad is transmitted as DTMF-tone to the Base Unit. The CM8880 will capture and stored each digit of the dialed phone number in the Base Unit as electronic signals. As each number is entered, the Base Unit will check to see it the cumulative number and order of the digits collected constitutes a valid phone number (i.e. 212, 01100, 91119999999 are invalid and 12125551234, 0, 911, and 2125551234 are valid). The Base Unit needs to evaluate the capture phone number to see if it is complete/valid, because the E-Phone will not have a Dial/Send key like there is on a cell phone. However, an E2Phone may have a send button just like a cell phone, in that case there will be no need to determine the validity of the phone number. When the E-Phone Base Unit's microprocessor detects a valid phone number, it will transmit is along with a Dial/Send Key signal to the cell phone microprocessor. The Dial command will tell the cell phone to execute the call: send the entered phone number out to the communication network. Once the call is placed the cell phone will serve as a conduit for the E-Phone, passing through the conversation as it occurs, and the call end signal.

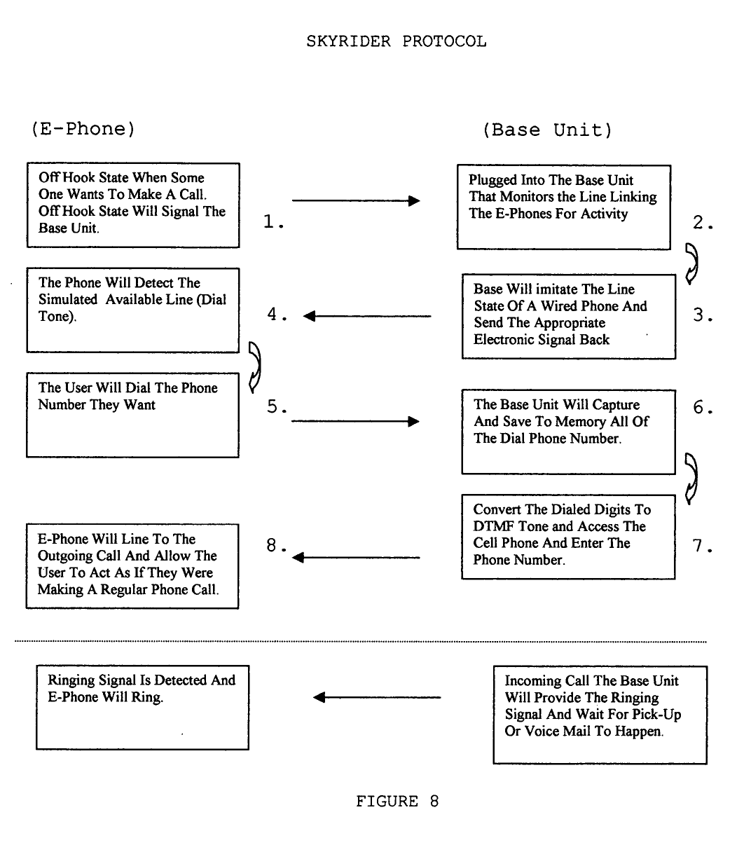

FIG. 8, is one embodiment of the events that occur as an E-Phone interacts with it Base Unit.

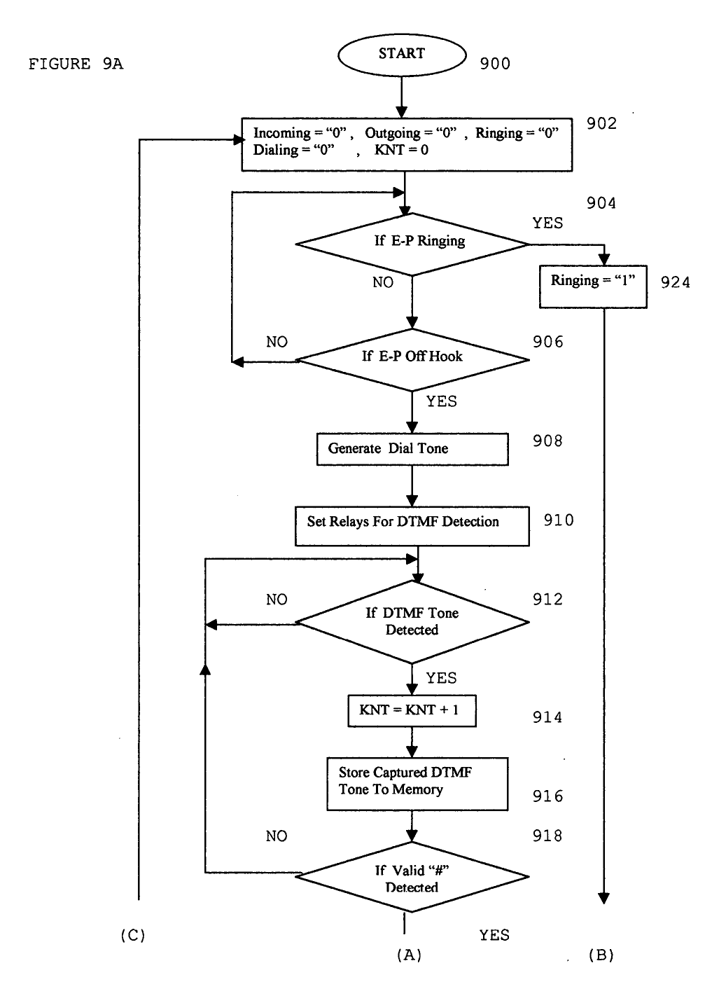

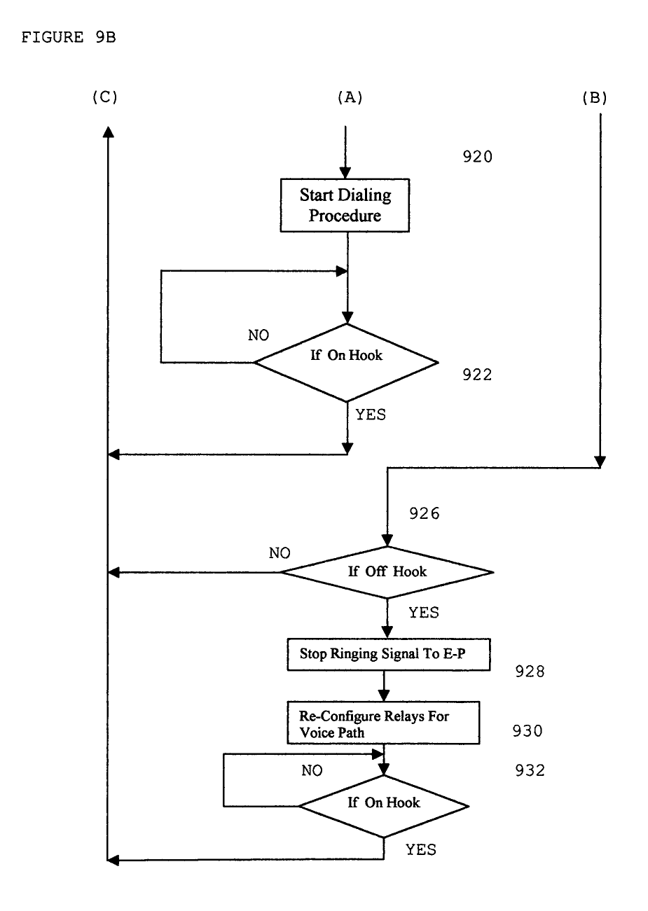

FIG. 9, is one embodiment of a flow chart showing the various step involved in the operation of a SkyRider. The first step in the SkyRider programming consist of initializing variables and flags (step 900-step 902). The next step in the operational coding of the SkyRider is to check the status of the cell phone (E-Phone) to determine if there is an incoming call (step 904). When the Base Unit detection of an incoming call it will trigger ringing in the E-Phone (E2Phone). If there is not ringing (incoming call) the SkyRider will next check to determine if an outgoing call is being attempted, by checking to see if the handset is out of the cradle (Off Hook). If the E-Phone (E2Phone) handset is not Off Hook, is the program will cycle through waiting for activity: incoming or outgoing call (step 904 to step 906). Once an Off Hook State is detected by the sensors array (FIG. 6, 122), the Base Unit will generate a dial tone, and configure the relay to bring the CM8880 into contact with the E-Phone wiring (steps 908 & step 910). This will allow the Base Unit to detect and capture the digits of the outgoing phone number (step 912 to step 916). The Base Unit will constantly check the collected digits to determine if the user has entered a valid phone number (step 918). This step may not be required in the E2Phones, if they have a Dial, Send, or Flash key build into their keypad (FIG. 10). Both the number of digits and the sequence of the digits will be used to help determine the validity of an entered phone number, and dialing will be executed (FIG. 9, step 920). In an alternate embodiment, an E2Phone will be equipped with a Send Key, or the functional equivalent of the key that is used in cell phones to execute the dialing process once the phone number is entered. After the E2Phone user has finished entering a telephone number, the user will press the Send Key to complete the dialing process. Once the call is initiated, the E2Phone will monitor for the end of the call (FIG. 9, step 922). The end of the call will be detected as an On Hook state, when the handset has been returned to the cradle, or the End key pressed (FIG. 10). The E2Phone will re-initialize all flags and variables after the call has ended, and await the next event (FIG. 9, step 902). When an incoming call is detected (ringing), the E2Phone will check the status of the handset to determine when the call is answer (FIG. 9, step 924-step 926). E2Phone will continue to ring until it is answered or the caller terminates the call (FIG. 9, step 902, 924, 926). If the phone is answered an Off Hook state is created, and the E2Phone will terminate the ringing, and activate the speaker and microphone circuits (FIG. 9, step 928 and step 930). The E2Phone will monitor for the end of the incoming call (FIG. 9, step 932). Once the call has ended, the E2Phone will re-initialize all flags and variables (FIG. 9, step 902).

FIG. 10 illustrates one embodiment of an E2Phone. The E2Phone has several features not common to an E-Phone, giving it greater functionality. The E2Phone has several additional buttons on its keypad than an E-Phone: “Send Key”, “Clear Key”, “End Key”, and “Flash Key”. When a user pressed a key on the E2Pone keypad, the Keypad Control Chip transmits a key specific signal to the microprocessor. The microprocessor will process the signal to determine what are the digits composing the entered phone number. As the user dial the phone number, the microprocessor will display the detected digits of the phone number, and alert the Base Unit to the pending outgoing call. The E2Phone will communicate with the Base Unit via the RJ11 phone line. In another embodiment the line linking the E2Phone to the Base Unit can be USB cable, Coaxial, fiber optics, or any other medium that can be used to link the two components together. The microprocessor monitors the line connecting the Speaker and Microphone to the Base Unit. The microprocessor can also relay the dialed digits of the entered phone number as DTMF-tone to the Base Unit over this connection. The microprocessor in the E2Phone generates a ringing signal when it encounters an incoming call indicator from the Base Unit. The microprocessor using its connection to the microphone can output a wide variety of signals; this will enable the E2Phone can generate a variety of ringing signals.

FIG. 11 illustrate one embodiment of an E2Phone that utilizes the components of the cell phone to make possible the operations of a SkyRider.

FIG. 12 illustrates one embodiment of an E3Phone. An E3Phone is a regular line phone that can interact with a cell phone. An E3Phone is a phone that has a docketing port for a cell phone. When a cell phone is docked with an E3Phone, it will be able to pass incoming wireless call into the line phone via the Connection Port (docking port). Once docked, the cell phone will allow the user to accept incoming call over the cell phone and the regular line phone. A series of relay will route the current desired call to the handset (speaker & microphone). If a call comes in while the speaker is talking to someone they will be able to put the call on hold, in and answer the new incoming call by pressing a key on the keypad (flash key, or a line key). The outgoing call will go through the line phone, but the cell phone can be make to accept outgoing call by making the line phone keypad input go to the cell phone by one of the above mentioned methods. The E3Phone would be similar to a two line phone, only one of the lines is wireless. The user will be able switch between the two lines or possibly hold a three-way conversation by linking the wireless and wire calls together.

It will be apparent to those skilled in the art that various modifications and variations can be made in the system and processes of the present invention without departing from the spirit or scope of the invention. Thus, it is intended that the present invention cover the modifications and variations of this invention provided they come within the scope of the appended claims and their equivalents. In this context, equivalents means each and every implementation for carrying out the functions recited in the claims, even if not explicitly described herein.

1. A method of adding an extension phone to a cell wireless telephonic device, comprising:
(a) Interfacing the a wireless telephonic device with one or more extension phone(s);
(b) the interfacing will allow each device to be aware of what is happening in the other device;
(c) the interfacing will allow each device to initiate activity within the other device;
(d) Each device will coordinate it activity with the other device.

2. The method of claim 1b, wherein extension phones will be able to detect incoming calls to the wireless telephonic device.

3. The method of claim 1c, wherein the extension phone will be able to make outgoing call through the wireless telephonic device.

4. The method of claim 1c, wherein the wireless telephonic device will be able to cause the extension phone signal an incoming call.

5. The method of claim 1b, wherein monitoring can detect when an incoming call is being answered at the extension phone.

6. A method of adding an extension phone to a cell wireless telephonic device, comprising:
(a) creating a module that will allow both a cell phone and an extension phone to interface with one another;
(b) the interfacing module will be able to monitor and initiate activity within either of the cell or extension phone;
(c) the cell phone can induce activity in the extension and the interfacing module;
(d) the extension phone can induce activity in the wireless phone and the interfacing module.

7. The method of claim 1b, wherein monitoring can detect incoming calls to the wireless telephonic device.

8. The method of claim 1b, wherein initiated activity can be signaling an incoming call at the extension phone(s).

9. The method of claim 1b, wherein monitoring can detect when an incoming call is being answered at the extension phone.

10. A method by which a wireless telephonic device can control the behavior of an extension phone, comprising:
(a) determining when the extension phone will be able to make outgoing calls;
(b) determining when the extension phone will be able to accept incoming calls;
(c) determining when the extension phone will signal an incoming call.
